(19) United States
(12) Patent Application Publication
(10) Pub. No.: US 2026/0290942 A1
(43) Pub. Date: Sep. 24, 2026

(54) MODULE ENCLOSURE FOR THERMAL RUNAWAY CONTAINMENT WITH MINIMAL MASS AND MANUFACTURING EASE

(71) Applicant: Wisk Aero LLC, Mountain View, CA (US)

(72) Inventor: Geoffrey Alan Long, Montara, CA (US)

(73) Assignee: Wisk Aero LLC, Mountain View, CA (US)

(21) Appl. No.: 19/573,777

(22) Filed: Mar. 20, 2026

Related U.S. Application Data
(60) Provisional application No. 63/775,580, filed on Mar. 21, 2025.

(51) Int. Cl. H01M 10/6567; H01M 10/04; H01M 10/613; H01M 10/651; H01M 10/653; H01M 10/6557; H01M 50/224

(52) U.S. Cl. CPC H01M 10/6567; H01M 10/0481; H01M 10/613; H01M 10/651; H01M 10/653; H01M 10/6557; H01M 50/224

(57) ABSTRACT

A module for containment of thermal runaway is disclosed. The module includes a plurality of stacked cells connected via cell interconnects and an enclosure formed from titanium configured to receive the plurality of stacked cells. The module further includes a plurality of channels formed from aluminum and configured to circulate a liquid to provide cooling to the plurality of stacked cells. The plurality of channels are located between the plurality of stacked cells and an interior surface of the enclosure. The module further includes a first adhesive located between a first side of the plurality of channels and the interior surface of the enclosure, the first adhesive configured to secure the interior surface of the enclosure to a surface of the plurality of channels, and thermal interface material located between the plurality of channels and the plurality of stacked cells.

### CROSS-REFERENCES TO RELATED APPLICATIONS

This application claims benefit under 35 USC§ 119(e) to U.S. Provisional Patent Application No. 63/775,580 filed Mar. 21, 2025, and entitled "MODULE ENCLOSURE FOR THERMAL RUNAWAY CONTAINMENT WITH MINIMAL MASS AND MANUFACTURING EASE,” the disclosure of which is incorporated by reference herein in its entirety for all purposes.

### BACKGROUND OF THE INVENTION

To comply with safety and certification requirements, especially in the transportation and aerospace sectors, effective containment of thermal runaway events in batteries is essential . Thermal runaway refers to a self-sustaining and uncontrolled reaction within a battery or module. This reaction can result in rapid increases in temperature and pressure, accompanied by emissions of flammable and/or toxic gasses from the battery. To mitigate the risks associated with thermal runaway, manufacturers typically implement battery cooling systems are and thermal management systems.

### BRIEF SUMMARY OF THE INVENTION

The present disclosure relates to systems and methods for battery module enclosures designed to contain thermal runaway events with minimal mass and ease of manufacturing. . The present disclosure provides a battery module enclosure that utilizes a titanium containment shell configured to withstand high-temperature and internal pressures, such as those generated during a thermal runaway event, providing a robust containment. The further implementation of aluminum-based cooling channels optimizes heat dissipation, leveraging the thermal conductivity of aluminum. This configuration is implemented to achieve efficient cooling and containment of thermal runaway events while minimizing the overall mass and manufacturing complexity of the module.

Various electric vehicles (e.g., aircraft, cars) employ batteries which can release a significant amount of heat and gases in the event of thermal runaway. To comply with safety and certification requirements, thermal runaway of a battery must be contained to mitigate such a generation of heat and gas. Conventional battery containment solutions often utilize titanium structures due to titanium’s high strength and resistance to heat.. However, titanium is less effective for cooling due to its low thermal conductivity. Moreover, titanium can be relatively heavy, which can be undesirable for certain implementations (e.g., aircraft) where there is a need to minimize the overall mass of components. Embodiments of the present disclosure provide a module for thermal runaway containment which utilizes a titanium containment enclosure adhered to a plurality of aluminum channels to provide efficient cooling to one or more batteries to contain thermal runaway, while reducing the cost and overall weight of the containment module.

### BRIEF DESCRIPTION OF THE DRAWINGS

FIG. 1 illustrates a cross-sectional view of a battery module for containing thermal runaway, according to various embodiments of the present disclosure;

FIG. 2 illustrates a cross-sectional view of the battery module for containing thermal runaway including a plate and thermal interface material, according to various embodiments of the present disclosure;

FIG. 3 illustrates a cross-sectional view of the battery module for containing thermal runaway with an enclosure including channels, according to various embodiments of the present disclosure;

FIG. 4A illustrates a method for manufacturing the battery module for containing thermal runaway, according to various embodiments of the present disclosure;

FIG. 4B illustrates a cross-sectional view of the method utilizing a lateral force, according to various embodiments of the present disclosure;

FIG. 4C illustrates a cross-sectional view of the method utilizing an angular force, according to various embodiments of the present disclosure; and

FIG. 4D illustrates a cross-sectional view of the method including a first, second, and third part forming at least a portion of the enclosure, according to various embodiments of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The figures and the following description relate to various embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Systems and methods of the present disclosure provide a module that addresses the need for minimal mass and ease of manufacturing while ensuring effective thermal runaway containment. Conventional methods for containing thermal runaway that may occur in one or more batteries often use titanium structures to house the batteries. However, titanium is a relatively heavy material and has low thermal conductivity, making it difficult to control thermal runaway. Embodiments of the present disclosure provide an enclosure including liquid cooling channels through which liquid (e.g., water, specialized coolants, etc.) may be circulated to cool stacked cells housed in the enclosure. The module can be composed of both titanium components and aluminum components, addressing the need in the art for devices that have reduced loads with high thermal conductivity and efficiency to contain thermal runaway in accordance with industry requirements. The disclosed module may be suitable for use in electric or hybrid vehicles, including, but not limited to, electric aircraft, automobiles, and stationary energy storage systems. For example, an eVTOL aircraft may be outfitted with a plurality of the modules described herein to mitigate the risk of thermal runaway.

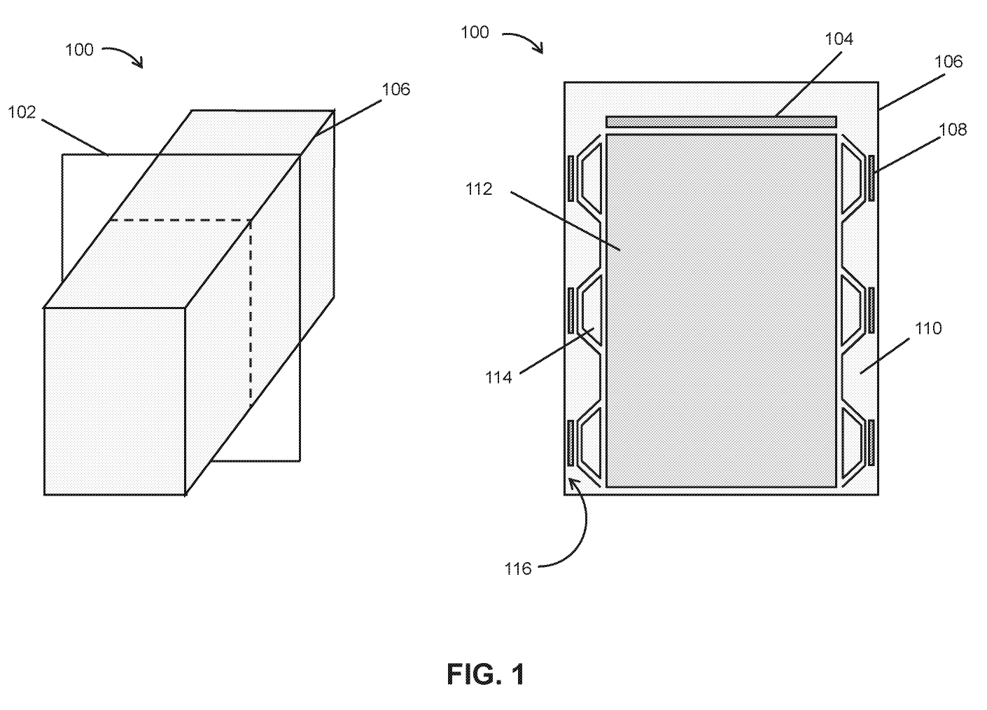

FIG. 1 illustrates a cross-sectional view of a battery module 100 for containing thermal runaway, according to various embodiments of the present disclosure. As shown, the battery module 100 may include an enclosure 106, a plurality of channels 110, adhesive 108, thermal interface material 114, and a plurality of stacked cells 112. The arraignment and configuration of the components of the battery module 100 may support both thermal management and containment in the event of a thermal runaway event.

In various embodiments, a plurality of stacked cells 112 are included in the battery module 100. For example, a battery may be utilized on an electric or hybrid vehicle where the battery consists of an arrangement of stacked cells 112. The stacked cells 112 may include various types, such as pouch cells or prismatic cells, and may be selected based on the performance, durability, safety, or other requirements of the application.. For example, the type of stacked cells 112 selected may be pouch cells which are flexible and perform better under pressure. The battery module 100 may further include cell interconnects 104 to connect the plurality of stacked cells 112. For example, cell interconnects 104 may be used to join a plurality of stacked cells 112 to create a battery. As previously discussed, thermal runaway may occur in a battery when one or more of the stacked cells 112 fails generating significant heat.

To contain the potential thermal runaway, an enclosure 106 may be used. The enclosure 106 may serve as a structural housing for the battery module 100. In various embodiments, the enclosure 106 may be formed from titanium. However, while the enclosure 106 is discussed herein as being formed from titanium, it is to be understood that any suitable material for containing thermal runaway may be used to form the enclosure 106. The enclosure 106 may be configured to house the plurality of stacked cells 112 and may be dimensioned to accommodate variations in cell size or arrangement, depending on the application. Moreover, the enclosure 106 may be utilized to contain heat and/or gases that may be generated by the plurality of stacked cells 112 when experiencing thermal runaway. For example, in an instance where a battery is experiencing thermal runaway, the titanium enclosure 106 may prevent the transfer of heat to other vehicle components or the dissemination of gases to other areas of the vehicle.

Positioned between the stacked cells 112 and the interior surface 116 of the enclosure 106, a plurality of channels 110 may be provided to support cooling of the plurality of stacked cells 112. For example, the plurality of channels 110 may be coupled to a wall of the enclosure 106 (i.e., the interior surface 116) such that the enclosure 106 and the plurality of channels 110 may be utilized to contain the plurality of stacked cells 112. The plurality of channels 110 may be configured to circulate liquid, such as water or specialized coolant, to provide cooling to the plurality of stacked cells 112. For example, the plurality of channels 110 may be aligned laterally along one or more walls of the enclosure 106 such that cooling liquid can pass through the plurality of channels 110 along the exterior of the plurality of stacked cells 112. As a result, heat may be transferred through the plurality of channels 110 from the stacked cells 112 to the cooling liquid to control the temperature of the stacked cells 112. In an embodiment, one or more of the channels 110 may be connected to provide a path to circulate the fluid. For example, the channels 110 on one side of the battery module 100 may be configured to make a serpentine pattern along the side of the enclosure 106. Additionally, or alternatively, one or more of the channels 110 may be separate to provide individual paths to circulate fluid. In various embodiments, the plurality of channels 110 may be formed from a material that is different from the material used to form the enclosure 106. For example, the plurality of channels 110 may be formed from a material with a higher coefficient of thermal conductivity than the material used to form the enclosure 106. In various embodiments, the plurality of channels 110 may be formed from aluminum. Since aluminum has relatively high thermal conductivity as compared to other materials such as titanium, heat may more efficiently be transferred between the liquid traveling through the plurality of channels 110 formed from aluminum and the plurality of stacked cells 112 located adjacent to the plurality of channels 110. While the plurality of channels 110 are discussed herein as being formed from aluminum, it is to be understood that any material with suitable thermal conductivity may be used to form the plurality of channels 110.

Utilizing different materials for the enclosure 106 and the plurality of channels 110 can provide benefits in terms of overall performance. For example, forming the enclosure 106 out of titanium can contribute to robust containment, while forming the plurality of channels 110 out of aluminum may optimize thermal conductivity, reduce weight, and facilitate manufacturing. The combination of these materials may allow for improved containment and cooling with minimized mass, which can be particularly valuable for applications where weight reduction is a priority, such as in aerospace or automotive contexts.

An adhesive 108 may be used to secure the enclosure 106 to the plurality of channels 110. For example, an adhesive 108 may be located between a first side of the plurality of channels 110 and the interior surface 116 of the enclosure 106. The adhesive 108 may be selected for compatibility with both titanium and aluminum, as well as for properties such as thermal conductivity and mechanical strength. For example, in the example with a titanium enclosure 106 and aluminum channels 110, the adhesive 108 may be used in lieu of other methods, such as welding, to attach the enclosure 106 to the channels 110. Any suitable adhesive may be used to secure the channels 110 to the interior of the enclosure 106. For example, film adhesives may be positioned between the enclosure 106 and the channels 110 to fasten the two components together.

A thermal interface material 114 may be included in the battery module 100. In various embodiments, the thermal interface material 114 may be located between the plurality of channels 110 and the plurality of stacked cells 112. The thermal interface material 114 may be configured to partially or entirely fill a space between the plurality of channels 110 and the plurality of stacked cells 112. For example, as illustrated in FIG. 1, the thermal interface material 114 may form to the space between the plurality of channels 110 and the plurality of stacked cells 112 filling the space. In another example, the thermal interface material 114 may line the ridges of the plurality of channels 110 without entirely filling the space between the plurality of channels 110 and the plurality of stacked cells 112. In various embodiments, the thermal interface material 114 may be viscous or semi-viscous, such that the thermal interface material 114 can conform to surface irregularities and maximize the thermal contact between adjacent components.

The disclosed battery module 100 may support effective thermal management and containment during both normal operation and in the event of a thermal runaway. Heat generated by the stacked cells 112 may be transferred through the thermal interface material 114 to the aluminum channels 110, where it can be absorbed by circulating coolant and removed from the module 100. The enclosure 106 may contain the stacked cells 112 and any gases produced during a thermal runaway event, while the combination of lightweight channels 110 and robust enclosure 106 may help balance thermal performance, weight, and manufacturing complexity.

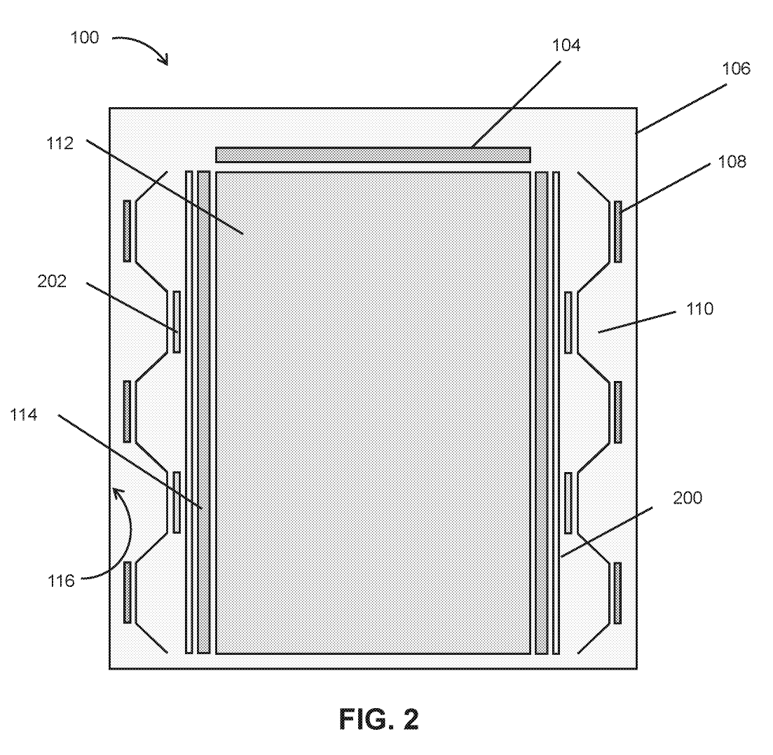

FIG. 2 illustrates a cross-sectional view of the battery module 100 for containing thermal runaway including a plate 200 and thermal interface material 114, according to various embodiments of the present disclosure. In various embodiments, the battery module 100 may further include a plate 200 housed within the enclosure 106. The plate 200 may be positioned between the plurality of channels 110 and the thermal interface material 114. For example, a first side of the plate 200 may be located adjacent to the plurality of channels 110 and the second side of the plate 200 may be located adjacent to the thermal interface material 114, as shown in FIG. 2. In various embodiments, the plate 200 may be formed of a material with high thermal conductivity. For example, the plate 200 may be formed from aluminum. In various embodiments, the plate 200 may be formed from the same or similar material as the plurality of channels 110. The use of aluminum for the plate 200 can enable rapid and uniform distribution of heat transferred from the stacked cells 112 through the thermal interface material 114, further promoting the effectiveness of the cooling channels 110. The plate 200 may provide a suitable surface for engagement with the thermal interface material 114, supporting reliable and repeatable assembly, as well as enhanced thermal coupling across the interface. The presence of the plate 200 can also serve to distribute mechanical stresses that may arise from thermal cycling or assembly processes, helping to maintain the structural integrity of the module during operation and over its service life.

In various embodiments, adhesive 202 may be utilized to secure the plate 200 to the plurality of channels 110. The adhesive 202 may be located between the plate 200 and the plurality of channels 110. The adhesive 202 may exhibit thermal conductivity properties to support efficient heat transfer and may be selected for compatibility with the plate 200 and/or the plurality of channels 110. Selection of adhesive 202 may also consider factors such as mechanical strength, outgassing characteristics, and ease of manufacturing. In various embodiments, the adhesive 202 may be the same as the adhesive 108 located between the plurality of channels 110 and the enclosure 106. In alternative embodiments, the adhesive 202 located between the plate 200 and the plurality of channels 101 may be different than the adhesive 108 located between the plurality of channels 101 and the enclosure 106. In various embodiments, either or both adhesives 108, 202 may be thermally conductive adhesive.

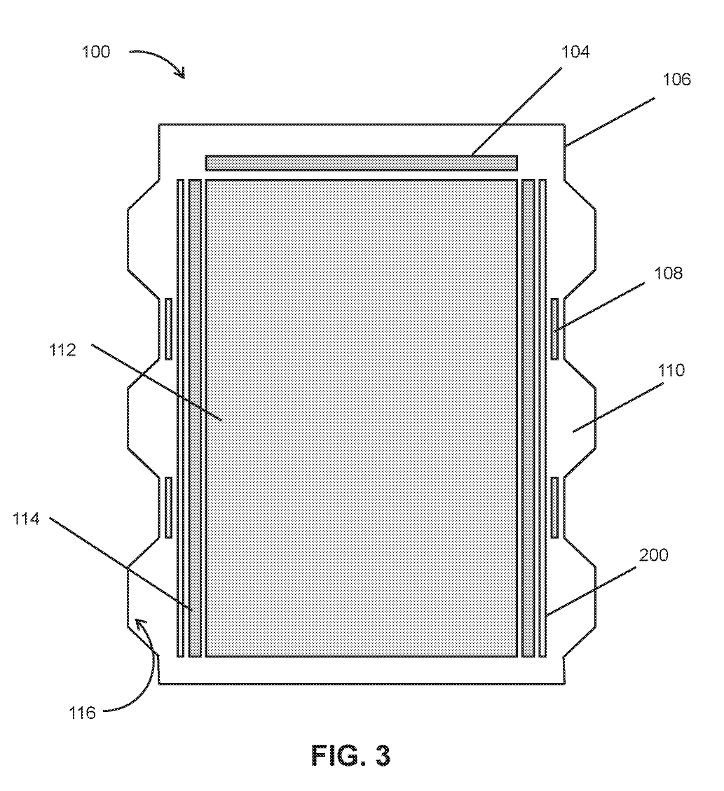

FIG. 3 illustrates a cross-sectional view of the battery module 100 for containing thermal runaway with an enclosure 106 including channels 110, according to various embodiments of the present disclosure. In various embodiments, the enclosure 106 may include the plurality of channels 110 configured to circulate liquid to provide cooling to the plurality of stacked cells 112. For example, as shown in FIG. 3, the enclosure 106 may be manufactured such that a plurality of channels 110 are formed integrally within the wall of the enclosure 106, rather than being provided as separate components attached to the interior surface 116.

In this configuration, the enclosure 106 may be engineered so that the wall structure of the enclosure 106 includes one or more channels 110 that are either cast, extruded, machined, or otherwise incorporated directly into the material of the enclosure 106. The plurality of channels 110 may be shaped and/or oriented to facilitate the circulation of a coolant fluid, such as water or a specialized heat transfer liquid, along paths that are proximate to the stacked cells 112. By integrating the channels 110 into the enclosure wall, the cooling function can be accomplished without the need for separate channel components, adhesives, or additional assembly operations that would otherwise be required for joining discrete parts.

The material selected for the enclosure 106 in this embodiment may be optimized to balance the requirements for structural containment and thermal conductivity. For example, the enclosure 106 may be formed from a titanium alloy for its high strength and heat resistance, while the plurality of channels 110 may be engineered within the same material or may be lined or coated with a secondary material to enhance thermal performance. The integrally formed channels 110 may be dimensioned and patterned to maximize coolant contact area, optimize fluid flow characteristics, and ensure uniform temperature regulation across the module 100.

The present of the plurality of channels 110 in the enclosure 106 can reduce the overall mass and/or complexity of the battery module 100 . By eliminating the need for separate channel components and the associated adhesives or fasteners, the module 100 can be lighter and less costly to manufacture. This configuration may also improve mechanical robustness by reducing the number of interfaces and potential points of failure within the module 100.

The thermal interface material 114 may be positioned between the interior surface 116 of the enclosure 106 (i.e., between the integrally formed channels 110 and the stacked cells 112) to promote effective heat transfer from the cells 112 into the wall of the enclosure 106 and into the coolant fluid circulating within the channels 110. In various embodiments, a viscous, or semi-viscous thermal interface material 114 may be utilized, further enhancing thermal coupling, minimizing air gaps, and ensuring consistent module performance under varying operating conditions.

In operation, heat generated by the stacked cells 112 may be conducted through the thermal interface material 114 and/or plate 200 and into the wall of the enclosure 106, where the heat is absorbed by the coolant fluid moving through the integrally formed channels 110. This direct path from the cells 112 to the cooling medium can contribute to rapid and efficient dissipation of heat, which may be particularly valuable for applications requiring stringent thermal management and minimal weight, such as electric aircraft, automotive battery systems, or stationary storage installations. By integrating the plurality of channels 110 within the enclosure 106 wall, the arrangement depicted in FIG. 3 may offer a simplified and robust solution for thermal runaway containment and management, supporting both manufacturing ease and operational reliability.

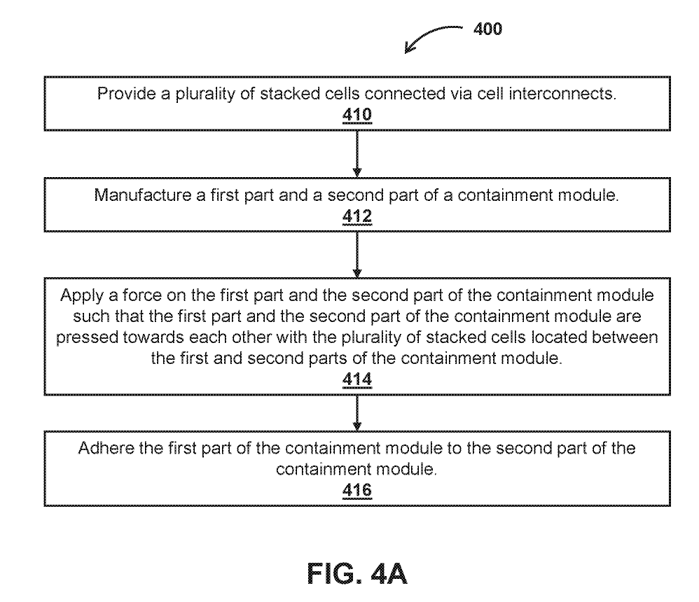

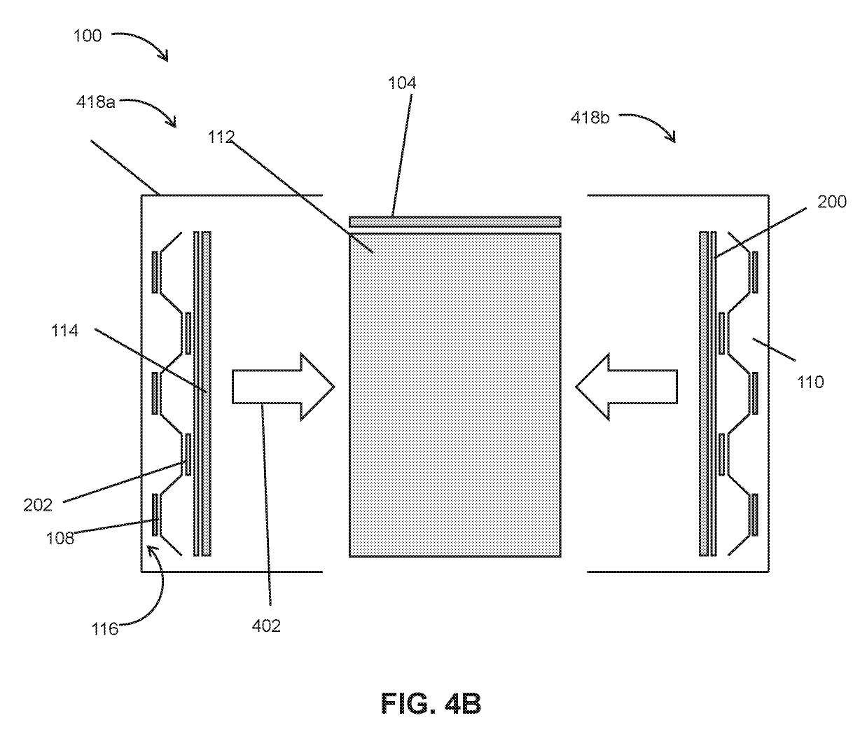

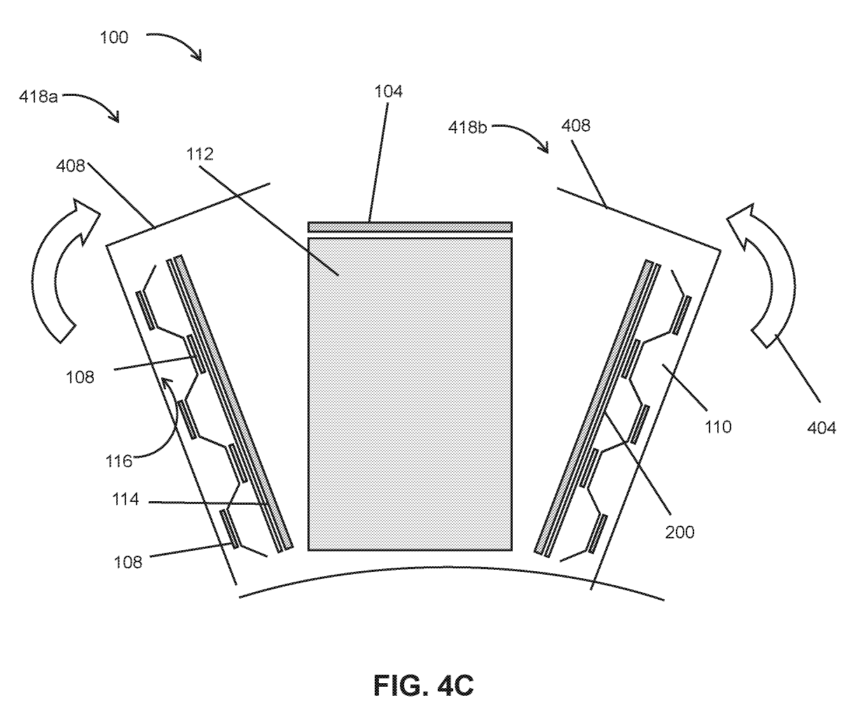

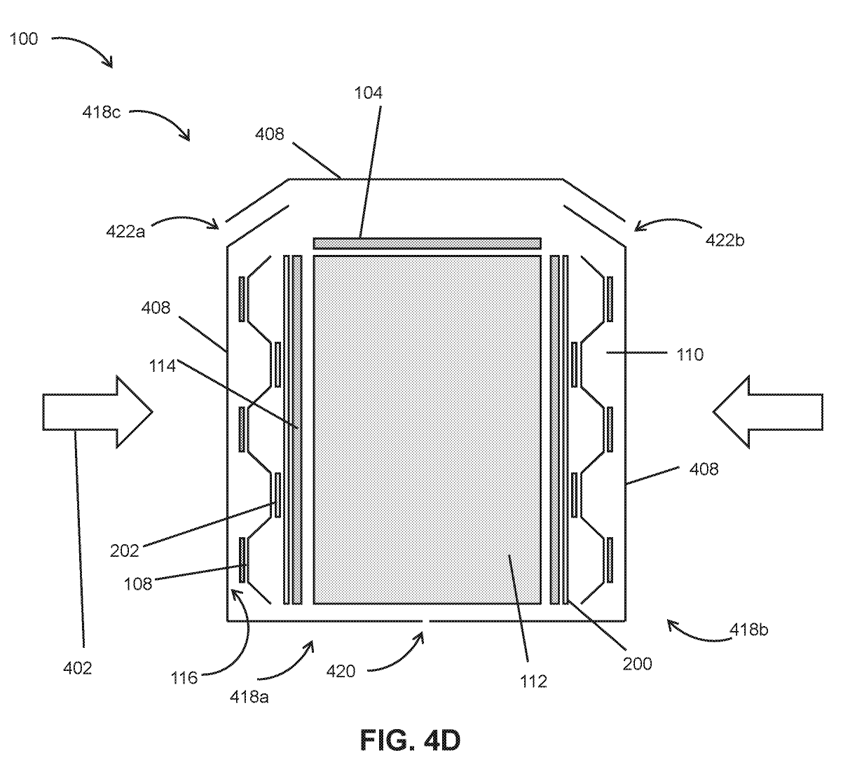

FIG. 4A illustrates a method 400 for manufacturing the battery module 100 for containing thermal runaway; FIG. 4B illustrates a cross-sectional view of the method 400 utilizing a lateral force 402; FIG. 4C illustrates a cross-sectional view of the method 400 utilizing an angular force 404; and FIG. 4D illustrates a cross-sectional view of the method 400 including a first 418a, second 418b, and third part 418c forming at least a portion 408 of the enclosure 106, according to various embodiments of the present disclosure. In an example, a battery module 100 may be manufactured by assembling components separately and combining the assembled parts 418 to produce the battery module 100.

The method 400 may begin at operation 410, where a plurality of stacked cells 112 connected via cell interconnects 104 are provided. The stacked cells 112 may include various types of cells utilized for particular applications. For example, the stacked cells 112 may be pouch cells which are flexible and perform better under pressure. The cell interconnects 104 may be configured to electrically connect the cells 112 in series or parallel arrangements.

The method 400 further includes operation 412, where at least a first part 418a and a second part 418b of a battery module 100 are manufactured. The first and second parts 418a, 418b each comprise at least a portion 408 of an enclosure 106. These parts 418 may be manufactured as a single body, as illustrated in FIG. 4C, or as multiple separate bodies, as illustrated in FIG. 4B and 4D. For example, as illustrated in FIG. 4C, the first part 418a and the second part 418b may be manufactured as a single body where the enclosure 106 has an open top and a bendable bottom, such that, as the bottom bends, the top opening widens, facilitating cell 112 insertion. In another example, as illustrated in FIG. 4B, the enclosure 106 may consist of two separate C-shaped parts 418a, 418b which are combined to form at least a portion 408 of the enclosure 106. In another example, as illustrated in FIG. 4D, two separate C-shaped parts 418a, 418b may be provided along with a third part 418c. In the FIG. 4D configuration, the two side parts 418a and 418b, may be configured for lateral joining and the third top part 418c may be configured to close a gap at the top, after the side parts 418a, 418b are combined. As previously discussed, the parts 418 of the enclosure 106 may be formed from high-performance materials such as titanium to provide mechanical strength and thermal resilience.

The enclosure 106 may further include a plurality of channels 110 and one or more plates 200. The plurality of channels 110 may be located adjacent to an interior surface 116 of the parts 418a418b and the plates 200 may be located adjacent to the plurality of channels 110. To optimize performance, the plurality of channels 110 and/or plate 200 may be made from thermally conductive metals such as aluminum. The first and second parts 418a, 418b of the battery module 100 may also include adhesive 108, 202. The Adhesive 108 may be located between the plurality of channels 110 and the interior surface 116 of the enclosure 106. For example, adhesive 108 may be utilized to secure a surface of the plurality of channels 110 to the interior surface 116 of the enclosure 106. The Adhesive 202 may further be located between the plurality of channels 110 and the plate 200 such that the plate 200 is secured to the plurality of channels 110.

The method 400 further includes operation 414, where a force 402, 404 may be applied to the first part 418a and the second part 418b of the battery module 100 such that the first part 418a and the second part 418b of the battery module 100 are pressed towards each other. A plurality of stacked cells 112 may be positioned between the first and second parts 418a, 418b of the battery module 100 such that the plurality of stacked cells 112 may be enclosed with the first part 418a and the second part 418b when pressed together. The application of force may be accomplished in different ways, depending on the configuration of the enclosure 106. In various embodiments, a lateral force 402 may be applied to the first and second parts 418a, 418b, as shown in FIG. 4B and 4D. In various embodiments, an angular force 404 may be applied to the first and second parts 418a, 418b, as shown in FIG. 4C. For example, as shown in FIG. 4C, the stacked cells 112 may inserted through the widened top opening created by the bent bottom of the enclosure 106. Once the cells 112 are in place, an angular force 404 may be applied to the walls of the enclosure 106, unbending the bottom and closing the top opening to complete the enclosure 106 around the stacked cells 112. The application of force 402, 404 may not only secure the enclosure 106 but may also serve to compress the thermal interface material 114 between the plurality of stacked cells 112 and the plate 200, ensuring even distribution and optimal thermal contact. In various embodiments, the thermal interface material 114 may be viscous or semi-viscous, such that when the force 402, 404 is applied to the first and second parts 418a, 418b, the viscous or semi-viscous thermal interface material 114 may more effectively spread. Thus, full coverage of thermal interface material 114 can be achieved between the plurality of stacked cells 112 and the plate 200 while also achieving a thin layer of thermal interface material 114. The thickness of the viscous or semi-viscous thermal interface material 114 may, in turn, be based at least in part on the degree of lateral force 402 applied to the first and second parts 418a, 418b. For example, a thin layer of interface material 114 may be achieved by increasing the magnitude of the applied force 402, 404, thereby tailoring the module 100 for specific thermal management requirements.

The method 400 further includes operation 416, where the first part 418a of the battery module 100 is adhered to the second part 418b of the battery module 100. Adhesion can be implemented at one or more strategic locations to ensure robust assembly. In various embodiments, at least two locations will be adhered to secure the first part 418a to the second part 418b. For example, as shown in FIG. 4B, the top and bottom where the first and second parts 418a, 418b meet may both be adhered to secure the battery module 100. In another example, as shown in FIG. 4C, the bottom where the first part 418a and the second part 418b meet may be secured and a third part 418c will be adhered to the first part 418a and to the second part 418b. In various embodiment, only one location will be adhered to secure the first part 418a to the second part 418b. For example, as shown in FIG. 4C, the first part 418a and the second part 418b remain attached at the bottom, while a gap remains at the top of the enclosure 106. When the gap at the top of the first part 418a and second part 418b is present, the bottom portion of the enclosure 106 may be flexed. Then, as the top of the first part 418a and second part 418b are brought together by applying an angular force 404 to the enclosure 106, the bottom of the enclosure 106 will straighten and the top, where the first part 418a and second part 418b meet, may be adhered. Various adhesion techniques are suitable, including but not limited to high-performance adhesives, welding, or fasteners, chosen based on the enclosure material and operational demands

Although the battery module 100 is illustrated and described herein as including two separate parts 418 being combined at a top and bottom location to form the enclosure 106, as illustrated in FIG. 4B, or two parts 418a, 418b forming a single body and being combined at a top location to form the enclosure 106, as illustrated in FIG. 4C, the enclosure 106 may be formed from any number of parts 418 requiring any number of bonding locations. In various embodiments, as illustrated in FIG. 4D, the enclosure 106 may include a first part 418a, a second part 418b, and a third part 418c (e.g., a top panel). In this configuration, the first part 418a and the second part 418b may be pressed together and adhered at a bottom location 420, while the third part 418c is subsequently adhered at two upper locations (422a, 422b), closing the enclosure 106. The sequence allows the top of the battery module 100 to remain open for assembly or maintenance access, such as for interconnect installation or inspection, until the final closure operation. The third part 418c may also be configured for removable or reversible attachment, allowing for future maintenance, inspection, or replacement of internal components without complete module disassembly.

Accordingly, various embodiments described herein may be used in any industrial or commercial application using batteries, such as lithium-ion batteries, where thermal runaway is a major safety risk. The disclosed system and methods are broadly applicable beyond lithium-ion systems, extending to any application where robust containment of thermal events is a priority, including but not limited to aerospace, automotive, stationary energy storage, and other high-reliability environments. The modular design and assembly flexibility further facilitate the integration of advanced cooling, monitoring, or safety subsystems as required by specific industrial standards or regulatory frameworks.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

Upon reading this disclosure, those of skill in the art will appreciate still additional alternative designs for the system. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in any claims drawn to the subject matter herein.

What is claimed is:

1. A module for thermal runaway containment comprising:
a plurality of stacked cells connected via cell interconnects;
an enclosure formed from a first material and configured to receive the plurality of stacked cells;
a plurality of channels formed from a second material and configured to circulate a liquid to provide cooling to the plurality of stacked cells, the plurality of channels located between the plurality of stacked cells and an interior surface of the enclosure, wherein the first material is different from the second material;
a first adhesive located between a first side of the plurality of channels and the interior surface of the enclosure, wherein the first adhesive is configured to secure the interior surface of the enclosure to a surface of the plurality of channels; and
thermal interface material located between the plurality of channels and the plurality of stacked cells.

2. The module for thermal runaway containment of claim 1, further comprising:
a plate formed with the second material, the plate with a first side located adjacent to the plurality of channels; and
a second adhesive configured to secure the first side of the plate to the plurality of channels.

3. The module for thermal runaway containment of claim 2, wherein the thermal interface material is located between a second side of the plate and the plurality of stacked cells.

4. The module for thermal runaway containment of claim 1, wherein the first material is titanium, and the second material is aluminum.

5. The module for thermal runaway containment of claim 2, wherein at least one of the first adhesive and the second adhesive is a thermally conductive adhesive.

6. The module for thermal runaway containment of claim 1, wherein the first material has a higher coefficient of thermal conductivity than the second material.

7. The module for thermal runaway containment of claim 1, further comprising a removable panel forming a portion of the enclosure, wherein the removable panel is configured to allow access to the plurality of stacked cells connected via cell interconnects.

8. A module for thermal runaway containment comprising:
a plurality of stacked cells connected via cell interconnects;
an enclosure configured to receive the plurality of stacked cells, the titanium enclosure comprising a plurality of channels configured to circulate a liquid to provide cooling to the plurality of stacked cells;
a plate with a first side and a second side, wherein the first side of the plate is located adjacent to the plurality of channels;
an adhesive located between the plurality of channels of the enclosure and the first side of the plate, wherein the adhesive is configured to secure an interior surface of the enclosure to the first side of the plate; and
thermal interface material located between the second side of the plate and the plurality of stacked cells.

9. The module for thermal runaway containment of claim 8, wherein the enclosure comprises at least two parts adhered together at a top location and a bottom location.

10. The module for thermal runaway containment of claim 8, wherein the plurality of channels are formed integrally within the interior surface of the enclosure.

11. The module for thermal runaway containment of claim 8, wherein the first material is titanium, and the second material is aluminum.

12. The module for thermal runaway containment of claim 9, wherein at least one of the first adhesive and the second adhesive is a thermally conductive adhesive.

13. The module for thermal runaway containment of claim 8, wherein the first material has a higher coefficient of thermal conductivity than the second material.

14. The module for thermal runaway containment of claim 8, further comprising a removable panel forming a portion of the titanium enclosure.

15. A method of manufacturing a module for thermal runaway containment comprising:
provide a plurality of stacked cells connected via cell interconnects;
manufacture a first part and a second part of a module, the first and second parts each comprising:
a portion of an enclosure formed from titanium;
a plurality of channels formed from aluminum and configured to circulate a liquid to provide cooling to the plurality of stacked cells, the plurality of channels located between the plurality of stacked cells and an interior surface of the portion of the enclosure;
a first adhesive located between a first side of the plurality of channels and the interior surface of the portion of the enclosure, wherein the first adhesive is configured to secure the interior surface of the portion of the enclosure to a surface of the plurality of channels;
an aluminum plate with a first side and a second side, wherein the first side of the aluminum plate is located adjacent to the plurality of channels;
a second adhesive configured to secure the first side of the aluminum plate to the plurality of channels; and
a thermal interface material located adjacent to the second side of the aluminum plate;
apply a force on the first part and the second part of the module such that the first part and the second part of the module are pressed towards each other with the plurality of stacked cells located between the first and second parts of the module; and
adhering the first part of the module to the second part of the module.

16. The method of claim 15, wherein the force is a lateral force.

17. The method of claim 15, wherein the force is an angular force.

18. The method of claim 15, wherein the thermal interface material is a viscous or semi-viscous compound such that, upon the application of force to the first part and the second part, the thermal interface material is spread between the second side of the aluminum plate and the plurality of stacked cells.

19. The method of claim 15, further comprising adhering a third part of the module to a first location on the first part and a second location on the second part.

20. The method of claim 19, wherein the third part is removably adhered, such that the third part is configured to allow access to the plurality of stacked cells connected via cell interconnects.
